(19) United States
(12) Patent Application Publication
(10) Pub. No.: US 2026/0197800 A1
(43) Pub. Date: Jul. 9, 2026

(54) RING ELECTRONIC DEVICE AND OPERATION METHOD THEREOF

(71) Applicant: SAMSUNG ELECTRONICS CO., LTD., Suwon-si (KR)

(72) Inventors: Dongil SON, Suwon-si (KR); Geonsoo KIM, Suwon-si (KR); Hyunsoo KIM, Suwon-si (KR); Jeongmin PARK, Suwon-si (KR); Bokun CHOI, Suwon-si (KR); Minkyung HWANG, Suwon-si (KR)

(21) Appl. No.: 19/556,208

(22) Filed: Mar. 4, 2026

Related U.S. Application Data
(63) Continuation of application No. PCT/KR2024/010773, filed on Jul. 25, 2024.

(30) Foreign Application Priority Data
Sep. 4, 2023 (KR) 10-2023-0117208
Oct. 5, 2023 (KR) 10-2023-0132862

(51) Int. Cl. H04W 64/00; H04L 12/18; H04W 88/06

(52) U.S. Cl. CPC H04W 64/006; H04L 12/189; H04W 88/06

(57) ABSTRACT

An operation method of a ring electronic device includes detecting coupling with a ring accessory device while the ring electronic device is operating in a first mode. The operation method of the ring electronic device further includes updating the operation mode of the ring electronic device to a second mode on the basis of the detection of the coupling. The first mode is a mode of transmitting information sensed by a sensor included in the ring electronic device to an external electronic device through a first communication method. The second mode is a mode of broadcasting information stored in the ring electronic device to the outside through a second communication method in order to track the location of the ring electronic device.

### CROSS-REFERENCE TO RELATED APPLICATIONS

This application is a continuation application, under 35 U.S.C. §111(a), of International Patent Application No. PCT/KR2024/010773, filed on July 25, 2024, which claims priority to Korean Patent Application No. 10-2023-0117208, filed on September 4, 2023, and Korean Patent Application No. 10-2023-0132862, filed on October 5, 2023, the content of which in its entirety is herein incorporated by reference.

### BACKGROUND

### 1. FIELD

Embodiments of the disclosure relate to a ring electronic device and an operation method thereof.

### 2. DESCRIPTION OF THE RELATED ART

A ring type wearable electronic device (hereinafter, "ring electronic device") may be an electronic device worn on a part (e.g., a finger) of a body of a user and capable of performing various functions. The ring electronic device may use at least one sensor to monitor a health state (e.g., a heart rate, sleep pattern, activity level, and/or stress level) of the user. The ring electronic device may track activity information (e.g., a location, posture, and/or motion) of the user. The ring electronic device may be linked to another electronic device and may provide the user with notifications (e.g., a call, text message, and/or email) from the other electronic device. The ring electronic device may provide payment functionality through near field communication (NFC).

The ring electronic device may be waterproof and wearable during exercise or daily life. The ring electronic device may have strong durability against impact in order to track activity of the user. By combining convenient and practical functions, the ring electronic device may enhance the user's life and help promote healthy habits.

The above information is presented as related art only to assist with an understanding of the disclosure. No determination has been made, and no assertion is made, as to whether any of the above might be applicable as prior art with regard to the disclosure.

### SUMMARY

An operation method of a ring electronic device in an embodiment may include detecting coupling with a ring accessory while the ring electronic device is operating in a first mode. The operation method of the ring electronic device may include updating an operation mode of the ring electronic device to a second mode based on the detection of the coupling. The first mode may be a mode of transmitting information sensed by a sensor included in the ring electronic device to an external electronic device through a first communication method. The second mode may be a mode of broadcasting information stored in the ring electronic device to an outside through a second communication method in order to track a location of the ring electronic device.

A ring electronic device in an embodiment may include a wireless communication circuit configured to transmit and receive a wireless signal. The ring electronic device may include a processor operatively connected to the wireless communication circuit. The ring electronic device may include memory storing instructions. The instructions, when executed individually or collectively by the processor, may cause the ring electronic device to detect coupling of the ring electronic device to an external electronic device while operating in a first mode. The instructions, when executed individually or collectively by the processor, may cause the ring electronic device to update an operation mode of the ring electronic device to a second mode, based on the detection of the coupling. The first mode may be a mode of transmitting information sensed by a sensor included in the ring electronic device to an external electronic device through a first communication method. The second mode may be a mode of broadcasting information stored in the ring electronic device to an outside through a second communication method in order to track a location of the ring electronic device.

An operation method of a ring electronic device in an embodiment may include detecting coupling of the ring electronic device to an external electronic device. The operation method of the ring electronic device may include updating an operation mode of the ring electronic device. The updated operation mode may be a mode in which the ring electronic device operates as an input device of the external electronic device.

A ring electronic device in an embodiment may include a wireless communication circuit configured to transmit and receive a wireless signal. The ring electronic device may include a processor operatively connected to the wireless communication circuit. The ring electronic device may include memory storing instructions. The instructions, when executed individually or collectively by the processor, may cause the ring electronic device to detect coupling of the ring electronic device to an external electronic device. The instructions, when executed individually or collectively by the processor, may cause the ring electronic device to update an operation mode of the ring electronic device based on the detection of the coupling. The updated operation mode may be a mode in which the ring electronic device operates as an input device of the external electronic device.

### BRIEF DESCRIPTION OF DRAWINGS

The above and other embodiments, advantages and features of this disclosure will become more apparent by describing in further detail embodiments thereof with reference to the accompanying drawings.

FIG. 1 is a block diagram illustrating an embodiment of an electronic device in a network environment.

FIG. 2 is a diagram illustrating an embodiment of a system for identifying a location of a user device.

FIGS. 3A and 3B are diagrams illustrating an embodiment of a structure of a ring electronic device.

FIG. 4 is a diagram illustrating an embodiment of a structure of a ring accessory device.

FIGS. 5A and 5B are diagrams illustrating an embodiment of coupling of a ring electronic device and a ring accessory device.

FIGS. 6A to 6C are diagrams illustrating an embodiment of coupling of a ring electronic device and a ring accessory device.

FIG. 7 is a diagram illustrating an embodiment of a ring accessory device.

FIG. 8 is a diagram illustrating an embodiment of an operation mode setting corresponding to a rotation of a ring electronic device.

FIG. 9 is a diagram illustrating an embodiment of an operation mode of a ring electronic device.

FIG. 10 is a diagram illustrating an embodiment of an operation method of a ring electronic device.

FIG. 11 is a diagram illustrating an embodiment of coupling of a ring electronic device and an electronic device.

FIG. 12 is a diagram illustrating an embodiment of coupling of a ring electronic device and an electronic device.

FIGS. 13 and 14 are diagrams illustrating an embodiment of coupling of a ring electronic device and an electronic device.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto will be omitted.

It will be understood that when an element is referred to as being “on” another element, it may be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” may therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” may, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

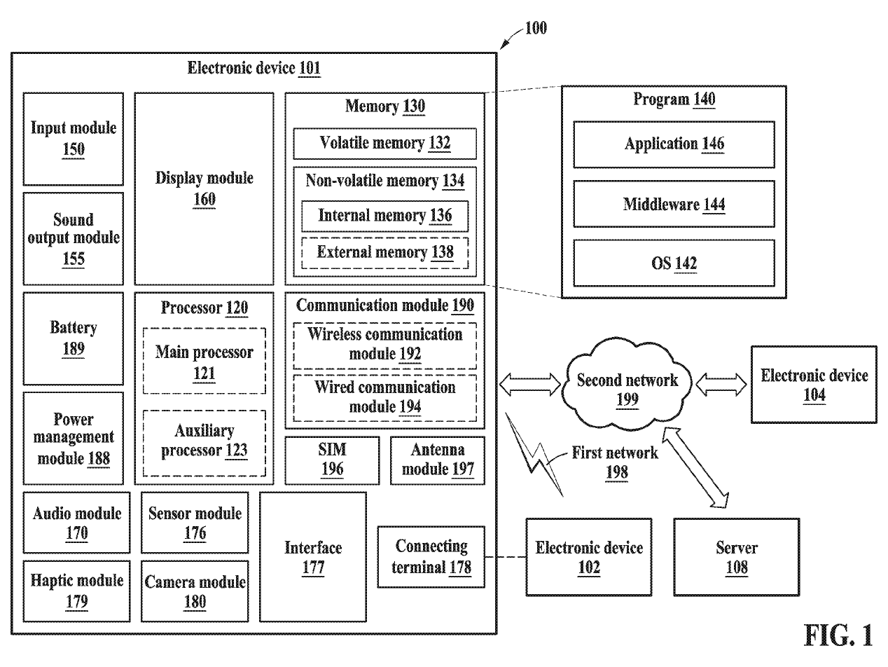

FIG. 1 is a block diagram illustrating an embodiment of an electronic device in a network environment.

FIG. 1 is a block diagram illustrating an embodiment of an electronic device 101 in a network environment 100. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). In an embodiment, the electronic device 101 may communicate with the electronic device 104 via the server 108. In an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be implemented as a single component (e.g., the display module 160).

The processor 120 may execute software (e.g., a program 140) to control at least one other component (e.g., a hardware or software component) of the electronic device 101 coupled with the processor 120, and may perform various data processing or computation, for example. In an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. In an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. In an embodiment, when the electronic device 101 includes the main processor 121 and the auxiliary processor 123, the auxiliary processor 123 may be adapted to consume less power than the main processor 121, or to be specific to a specified function, for example. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). In an embodiment, the auxiliary processor 123 (e.g., an ISP or a CP) may be implemented as part of another component (e.g., the camera module 180 or the communication module 190) functionally related to the auxiliary processor 123. In an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include software (e.g., the program 140) and input data or output data for a command related thereto, for example. The memory 130 may include the volatile memory 132 or the non-volatile memory 134.

The program 140 may be stored in the memory 130 as software, and may include an operating system (OS) 142, middleware 144, or an application 146, for example.

The input module 150 may receive a command or data to be used by another component (e.g., the processor 120) of the electronic device 101, from the outside (e.g., a user) of the electronic device 101. The input module 150 may include a microphone, a mouse, a keyboard, a key (e.g., a button), or a digital pen (e.g., a stylus pen), for example.

The sound output module 155 may output sound signals to the outside of the electronic device 101. The sound output module 155 may include a speaker or a receiver, for example. The speaker may be used for general purposes, such as playing multimedia or playing recordings. The receiver may be used for receiving incoming calls. In an embodiment, the receiver may be implemented as separate from, or as part of the speaker.

The display module 160 may visually provide information to the outside (e.g., a user) of the electronic device 101. The display module 160 may include a display, a hologram device, or a projector and control circuitry to control a corresponding one of the display, hologram device, and projector, for example. In an embodiment, the display module 160 may include a touch sensor adapted to detect a touch, or a pressure sensor adapted to measure the intensity of force incurred by the touch.

The audio module 170 may convert a sound into an electrical signal and vice versa. In an embodiment, the audio module 170 may obtain the sound via the input module 150, or output the sound via an external electronic device (e.g., an electronic device 102) (e.g., a speaker or headphone) directly (e.g., wiredly) or wirelessly coupled to the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. In an embodiment, the sensor module 176 may include a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor, for example.

The interface 177 may support one or more specified protocols to be used for the electronic device 101 to be coupled with the external electronic device (e.g., the electronic device 102) directly (e.g., wiredly) or wirelessly. In an embodiment, the interface 177 may include a high definition multimedia interface (HDMI), a universal serial bus (USB) interface, a secure digital (SD) card interface, or an audio interface, for example.

The connecting terminal 178 may include a connector via which the electronic device 101 may be physically connected with the external electronic device (e.g., the electronic device 102). In an embodiment, the connecting terminal 178 may include an HDMI connector, a USB connector, an SD card connector, or an audio connector (e.g., a headphone connector), for example.

The haptic module 179 may convert an electrical signal into a mechanical stimulus (e.g., a vibration or a movement) or electrical stimulus which may be recognized by a user via his tactile sensation or kinesthetic sensation. In an embodiment, the haptic module 179 may include a motor, a piezoelectric element, or an electric stimulator, for example.

The camera module 180 may capture a still image or moving images. In an embodiment, the camera module 180 may include one or more lenses, image sensors, ISPs, or flashes.

The power management module 188 may manage power supplied to the electronic device 101. In an embodiment, the power management module 188 may be implemented as at least part of a power management integrated circuit (PMIC), for example.

The battery 189 may supply power to at least one component of the electronic device 101. In an embodiment, the battery 189 may include a primary cell which is not rechargeable, a secondary cell which is rechargeable, or a fuel cell, for example.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and support a direct (e.g., wired) communication or a wireless communication. In an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth^{TM}, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a relatively high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or relatively large scale antenna. The wireless communication module 192 may support various requirements specified in the electronic device 101, an external electronic device (e.g., the electronic device 104), or a network system (e.g., the second network 199). In an embodiment, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 millisecond (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. In an embodiment, the antenna module 197 may include an antenna including a radiating element composed of a conductive material or a conductive pattern formed in or on a substrate (e.g., a printed circuit board (PCB)). In an embodiment, the antenna module 197 may include a plurality of antennas (e.g., array antennas). In such a case, at least one antenna appropriate for a communication scheme used in the communication network, such as the first network 198 or the second network 199, may be selected by the communication module 190 (e.g., the wireless communication module 192) from the plurality of antennas, for example. The signal or the power may then be transmitted or received between the communication module 190 and the external electronic device via the selected at least one antenna. In an embodiment, another component (e.g., a radio frequency integrated circuit (RFIC)) other than the radiating element may be additionally formed as part of the antenna module 197.

According to various embodiments, the antenna module 197 may form a mmWave antenna module. In an embodiment, the mmWave antenna module may include a PCB, a RFIC disposed on a first surface (e.g., the bottom surface) of the PCB, or next (adjacent) to the first surface and capable of supporting a designated high-frequency band (e.g., the mmWave band), and a plurality of antennas (e.g., array antennas) disposed on a second surface (e.g., the top or a side surface) of the PCB, or next (adjacent) to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

In an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. In an embodiment, all or some of operations to be executed at the electronic device 101 may be executed at one or more of the external electronic devices 102, 104, or 108. In an embodiment, when the electronic device 101 should perform a function or a service automatically, or in response to a request from a user or another device, the electronic device 101, instead of, or in addition to, executing the function or the service, may request the one or more external electronic devices to perform at least part of the function or the service, for example. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-Things (IoT) device. The server 108 may be an intelligent server using machine learning and/or a neural network. In an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

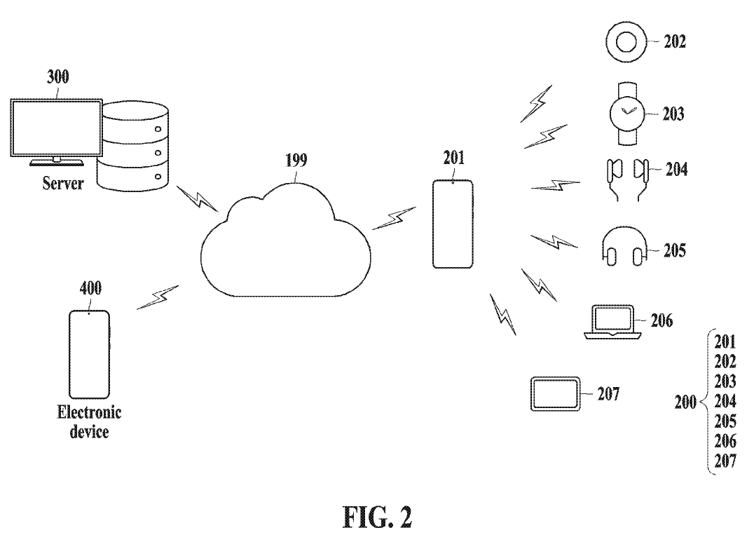

FIG. 2 is a diagram illustrating an embodiment of a system for identifying a location of a user device.

Referring to FIG. 2, a system in an embodiment may include user devices 200, a server 300, and an electronic device 400. The electronic device 400 and at least one device 201, 202, 203, 204, 205, 206, or 207 among the user devices 200 may be connected to the server 300 via the second network 199 (e.g., Wi-Fi or a cellular network).

In an embodiment, the user devices 200 may include a plurality of devices 201 to 207. In an embodiment, a user may own at least one of the second device 202, the third device 203, the fourth device 204, the fifth device 205, the sixth device 206, or the seventh device 207 in addition to the first device 201 that the user primarily uses, for example. The first device 201 may be a mobile communication device such as a smartphone. The second device 202 may be a ring-type wearable electronic device (hereinafter, a ring electronic device) that is worn on a part (e.g., a finger) of the user's body and performs various functions. The third device 203 may be a wearable device such as a smart watch. The fourth device 204 may be wireless earphones such as earbuds. The fifth device 205 may be Bluetooth headphones or a headset. The sixth device 206 may be a laptop. The seventh device 207 may be a tablet. In addition to the example shown in FIG. 2, the user may use other suitable devices in conjunction with the first device 201. In an embodiment, a key fob, a wallet, a backpack, a pet (e.g., dog or cat) recognition device, a car, a bicycle, an identification card, a briefcase, an umbrella, and/or other gear may also be devices that may be linked with the first device 201 provided that communication functions described in various embodiments of the disclosure are met, for example. When desired (e.g., in case of loss), the first device 201 may perform location tracking on a device that may be linked. Additionally, in an embodiment, a user may use two or more of the same device. In an embodiment, a user may use a plurality of smartphones (e.g., the first device 201) in conjunction with each other, for example. Furthermore, the user may use two or more tablets (e.g., the seventh device 207) in conjunction with the first device 201.

In an embodiment, the user devices 200 may be connected to each other using one or a plurality of communication protocols. In an embodiment, the first device 201 may be connected to at least one of the second device 202, the third device 203, the fourth device 204, the fifth device 205, the sixth device 206, or the seventh device 207 via a short-range network, for example. In an embodiment, a network (e.g., a short-range network) for establishing a connection between the user devices 200 may be appropriately selected, for example. In an embodiment, Bluetooth, Bluetooth low energy (BLE), Wi-Fi direct, near field communication (NFC), ultra-wide band (UWB) communication, and/or infra-red communication may be used to establish a connection between the user devices 200, for example. Additionally, in an embodiment, the user devices 200 may establish a connection using short-range wireless communication, such as a mesh network (e.g., Zigbee or Z-Wave).

In an embodiment, the user devices 200 may connect to each other in various ways depending on device information (e.g., device components). In an embodiment, among the user devices 200, the internet protocol (IP)-based (e.g., IP address) device 201, 202, 203, 204, 205, 206, or 207 may establish a connection with the second network 199 using a service set identifier (SSID), for example. In an embodiment, at least one 201, 202, 203, 204, 205, 206, or 207 of the user devices 200 may establish a connection with the second network 199 using a user device (e.g., the first device 201) or a hub device (not shown), for example.

In an embodiment, at least one 201, 202, 203, 204, 205, 206, or 207 of the user devices 200 may broadcast an advertising packet to provide a finding function in case of loss. In an embodiment, when the second device 202 determines that it is lost, various information including identification information of itself (e.g., the second device 202) may be broadcast through a packet, for example. The advertising packet may be broadcast so that one or a plurality of electronic devices disposed within a predetermined communication distance other than the second device 202 may receive the advertising packet. In the embodiments of the disclosure, a packet (e.g., an advertising packet) may be understood as a signal, a message, or a beacon.

In an embodiment, at least one 201, 202, 203, 204, 205, 206, or 207 of the user devices 200 may determine its loss state based on various criteria. In an embodiment, the second device 202 may determine that it has entered an offline state in which a connection with the first device 201 is lost, when a first period of time (e.g., 15 minutes) has elapsed since a last time the second device 202 was connected to a mother terminal or a main terminal, which is the first device 201, for example. The second device 202 may determine itself to be lost after a second period of time (e.g., 24 hours) has elapsed since entering the offline state, for example. The second device 202 may consider a remaining battery level in addition to time when determining the loss state. In this case, the remaining battery level may be a remaining battery level of itself (e.g., the second device 202), and the time may be the first period of time (e.g., 15 minutes) and the second period of time (e.g., 24 hours). The first period of time and the second period of time and/or the remaining battery level may be subject to various loss determination criteria based on user settings or manufacturer standards.

In an embodiment, the description of the electronic device 101 of FIG. 1 may be appropriately applied to the user devices 200. In an embodiment, when the first device 201 of a user is a smartphone, the first device 201 and the electronic device 101 may be substantially the same device, for example. Additionally, when the fourth device 204 of the user is earbuds without a display, for example, descriptions of the electronic device 101 other than the part about the display module 160 may be appropriately applied to the fourth device 204.

In an embodiment, the server 300 may correspond to the server 108 of FIG. 1. The server 300 may provide a function for locating at least one device that is lost when at least one 202, 203, 204, 205, 206, or 207 of the devices 202, 203, 204, 205, 206, and 207 except for the first device 201 among the user devices 200 is lost.

In an embodiment, the electronic device 400 may be a device of a user other than an owner of the second device 202. The electronic device 400 may be in the vicinity of the second device 202 and may directly or indirectly obtain an advertising packet broadcast from the second device 202. The electronic device 400 may include a short-range communication circuit for receiving a signal broadcast by the second device 202 using a short-range communication method (e.g., Bluetooth). The electronic device 400 may include a location measuring circuit (e.g., a global positioning system (GPS) circuit) for measuring its own location. The electronic device 400 may include a long-range communication circuit (e.g., a communication circuit supporting a cellular network and/or a Wi-Fi network) for transmitting information about the second device 202 and its location to the server 300.

In an embodiment, the electronic device 400 may be a device (e.g., a smartphone) of the same type as the first device 201. Part of or all of the description of the electronic device 101 described with reference to FIG. 1 may be applied to the electronic device 400. Additionally, the descriptions of the configuration or function of the first device 201 in various embodiments of the disclosure may also be applied to the electronic device 400, but may not necessarily be limited thereto. The electronic device 400 may be any electronic device that supports the above-described communication function.

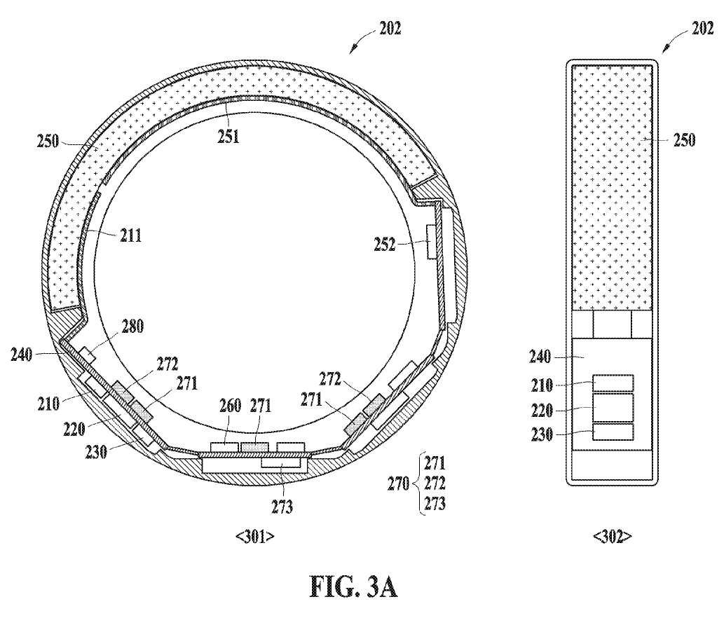

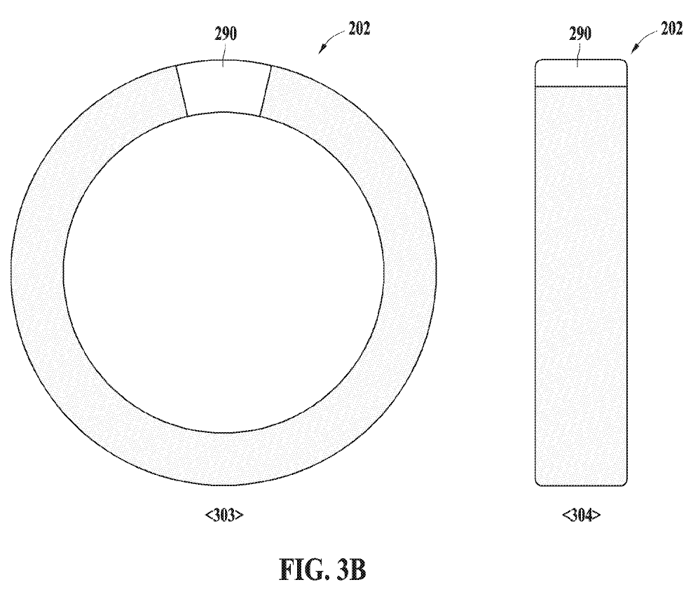

FIGS. 3A and 3B are diagrams illustrating an embodiment of a structure of a ring electronic device.

Referring to FIG. 3A, in an embodiment, a cross-sectional view 301 and a side perspective view 302 of the ring electronic device 202 (e.g., the second device 202 of FIG. 2) are illustrated. The ring electronic device 202 may be worn on a finger of a user (e.g., an adult). The ring electronic device 202 may be a smart ring. The ring electronic device 202 may have a shape with a hole defined at the center. In an embodiment, the ring electronic device 202 may be formed into an outer and an inner portion, for example. The outer portion of the ring electronic device 202 may be implemented to withstand external impact and scratches. The outer portion of the ring electronic device 202 may include or consist of a material (e.g., titanium, stainless steel, and/or ceramic) capable of implementing design elements. The inner portion of the ring electronic device 202 may be a portion that contacts a finger. The inner portion of the ring electronic device 202 may be implemented with the same material as that of the outer portion or a material (e.g., a molding material, transparent plastic, glass, and/or metal material) for sensing.

In an embodiment, the ring electronic device 202 may include a communication circuit 210, an antenna 211, a processor 220, a memory 230, a flexible printed circuit board (FPCB) substrate 240, a battery 250, a charging interface 251, a PMIC 252, an inertial sensor 260, a photoplethysmogram (PPG) sensor 270, and a temperature sensor 280.

In an embodiment, the communication circuit 210 may support the establishment of a direct (e.g., wired) communication channel or a wireless communication channel between the ring electronic device 202 and an external electronic device. The communication circuit 210 may support communication through the established communication channel. The communication circuit 210 may support various communication methods (e.g., Bluetooth, BLE, ZigBee, ANT+, Wi-Fi, Cellular (LTE, 5G, 6G, NB-IoT), NFC, radio-frequency identification (RFID), UWB, and/or global navigation satellite system (GNSS)). The communication circuit 210 may operate independently from the processor 220, or may be implemented in an integrated form with the processor 220. The antenna 211 may be an antenna for wireless communication. In an embodiment, the antenna 211 may be implemented as a single antenna or a plurality of antennas, for example. The antenna 211 may also be implemented as part of an exterior of the ring electronic device 202.

In an embodiment, the processor 220 may perform various data processing or operations. The processor 220 may store instructions or data received from other components (e.g., the sensors (e.g., 260, 270, and/or 280) or the communication circuit 210) in the memory 230, process the instructions or data stored in the memory 230, and store result data in the memory 230. In an embodiment, the processor 220 may be implemented as circuitry (e.g., processing circuitry) such as a system on chip (SoC) or an integrated circuit (IC). The processor 220 may include one or more processors. In an embodiment, the processor 220 may include a combination of one or more processors such as a CPU, a GPU, an MPU, an AP, and a CP, for example.

In an embodiment, the processor 220 may include a main processor (e.g., a CPU or an AP) or an auxiliary processor (e.g., a GPU, a neural processing unit (NPU), an ISP, a sensor hub processor, or a CP) that is operable independently from, or in conjunction with, the main processor. The processor 220 may be implemented in an integrated form with other components (e.g., the sensors (e.g., 260, 270, and/or 280) and/or the communication circuits 210).

In an embodiment, the memory 230 may store various data used by at least one component (e.g., the processor 220 and/or the sensors (e.g., 260, 270, and/or 280)) of the ring electronic device 202. The data may include input data or output data for software (e.g., a program) and instructions associated therewith, for example.

In an embodiment, the memory 230 may include one or more memories. Instructions stored in the memory 230 may be stored in a single memory. Instructions stored in the memory 230 may be divided and stored in a plurality of memories. Instructions stored in the memory 230 may be individually or collectively executed by the processor 220 to cause the ring electronic device 202 to perform and/or control operations of the ring electronic device 202 described with reference to FIGS. 3 to 14. Instructions stored in the memory 230 may be individually or collectively executed by a plurality of processors to cause the ring electronic device 202 to perform and/or control the operations of the ring electronic device 202 described with reference to FIGS. 3 to 14. In an embodiment, the FPCB substrate 240 may be an electric circuit having flexible characteristics. Components (e.g., the processor 220, the memory 230, the sensors (e.g., 260, 270, and/or 280), and/or the battery 250) may be placed on the FPCB substrate 240. The components placed on the FPCB substrate 240 may be electrically connected.

In an embodiment, the battery 250 may store energy to power the ring electronic device 202. The battery 250 may be charged and discharged, and may be formed from various materials (e.g., lithium ions, mercury, or other rechargeable battery chemistries). In an embodiment, the battery 250 may be disposed (e.g., mounted) with a flexible battery pack in order to be disposed inside the ring electronic device 202, for example. The charging interface 251 may support various charging schemes (e.g., a wired charging scheme and/or a wireless charging scheme) of the ring electronic device 202. The PMIC 252 may manage power of the ring electronic device 202. The PMIC 252 may appropriately distribute power to components (e.g., the processor 220 or the sensors (e.g., 260, 270, and/or 280)).

In an embodiment, the inertial sensor 260 may be a sensor that detects the inertia of the ring electronic device 202. In an embodiment, the inertial sensor 260 may include an acceleration sensor and/or a gyroscope sensor, for example. In an embodiment, the inertial sensor 260 may be implemented as a three-axis sensor, including a three-axis acceleration sensor, for example. In an embodiment, the inertial sensor 260 may be implemented as a six-axis sensor, including a three-axis acceleration sensor and a three-axis gyro sensor, for example. The inertial sensor 260 may sense a motion, gesture, impact, posture, and/or activity of the ring electronic device 202 (e.g., or a wearer of the ring electronic device 202). The ring electronic device 202 may include a location measuring circuit (e.g., a GPS circuit) (or a GPS sensor). Through the location measuring circuit (e.g., a GPS circuit) (or a GPS sensor), the ring electronic device 202 may obtain its own location information.

In an embodiment, the PPG sensor 270 may irradiate light onto a body (e.g., a wearer's body). The PPG sensor 270 may receive light that is absorbed, scattered, and/or reflected. The PPG sensor 270 may include an emitter 271. The emitter 271 may emit light of various bands. The emitter 271 may be implemented as various elements, e.g., a light-emitting diode (LED), a laser, or a vertical cavity surface emitting laser (VCSEL). The PPG sensor 270 may include a receiver 272. The receiver 272 may receive a result of reflected or transmitted light. The receiver 272 may be implemented as a photodiode and/or a complementary metal–oxide semiconductor (CMOS)-based image sensor, for example. The receiver 272 may convert received light based on an analog to digital converter (ADC). The receiver 272 may store a result of converting the received light in the memory 230 or a sensor buffer (not shown). The PPG sensor 270 may include a sensor controller 273. The sensor controller 273 may control the emitter 271 and the receiver 272. The sensor controller 273 may process (e.g., convert received light and store converted result in the memory 230) data.

In an embodiment, the temperature sensor 280 may be a sensor that measures a temperature of a living body or a component. The temperature sensor 280 may measure temperature in a contact or non-contact manner, for example. The temperature sensor 280 may store a measured temperature value in the memory 230. The temperature sensor 280 may transmit the measured temperature value to the processor 220, and cause the processor 220 to estimate a skin temperature. The ring electronic device 202 may include a sensor (e.g., a wearing detection sensor) that detects a user's finger.

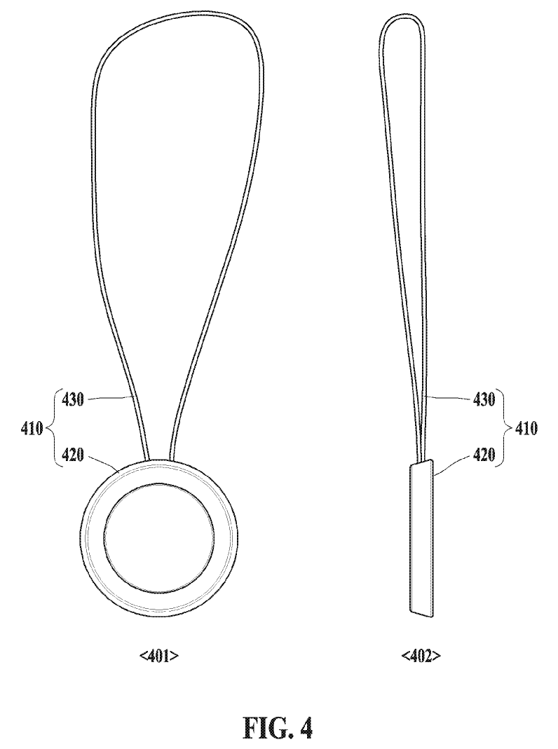

In an embodiment, the sensors (e.g., 260, 270, 280, and/or a wearing detection sensor) may be selectively activated depending on an operation mode of the ring electronic device 202. In an embodiment, in a mode (e.g., a health tracking mode) in which the ring electronic device 202 is worn on a user's finger to track a health state and/or activity information of the user (e.g., a wearer of the ring electronic device 202), all sensors (e.g., 260, 270, 280, and the wearing detection sensor) may be activated, for example. In an embodiment, when the user's finger is not detected, at least some of the health sensors (e.g., 260, 270, and 280) may be deactivated, and only the wearing detection sensor may be activated, for example. In an embodiment, when the user's finger is not detected and coupling with a ring accessory device (e.g., the ring accessory device 410 of FIG. 4) is detected, both the health sensors (e.g., 260, 270, and 280) and the wearing detection sensor may be deactivated, for example.

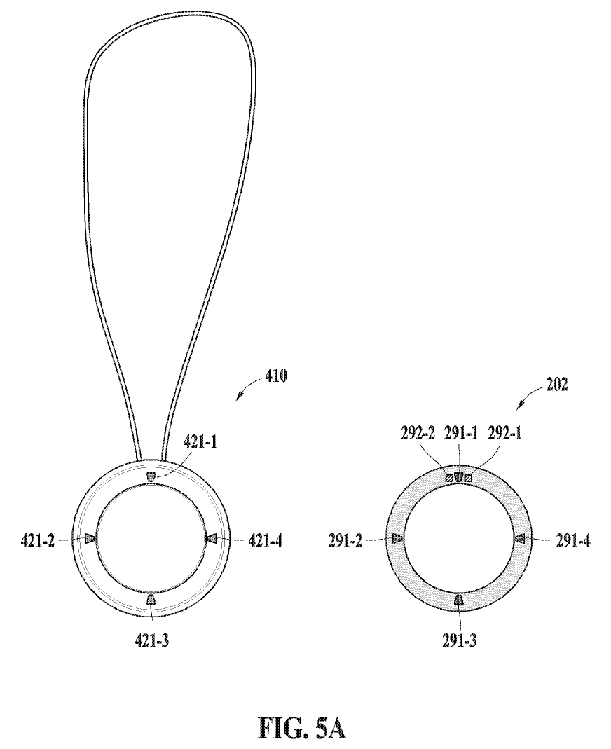

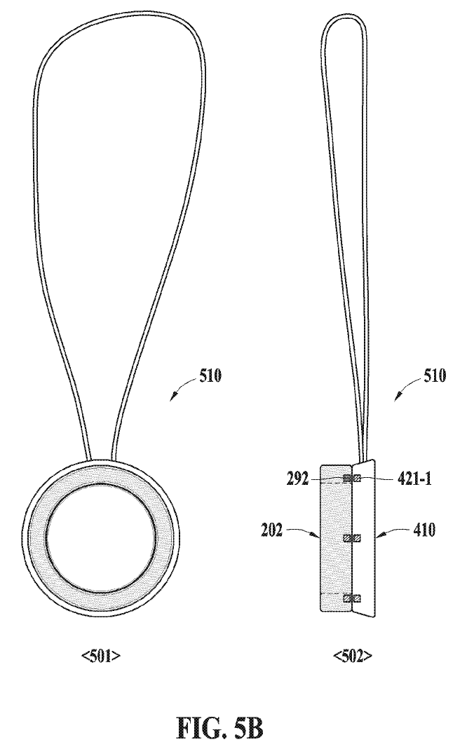

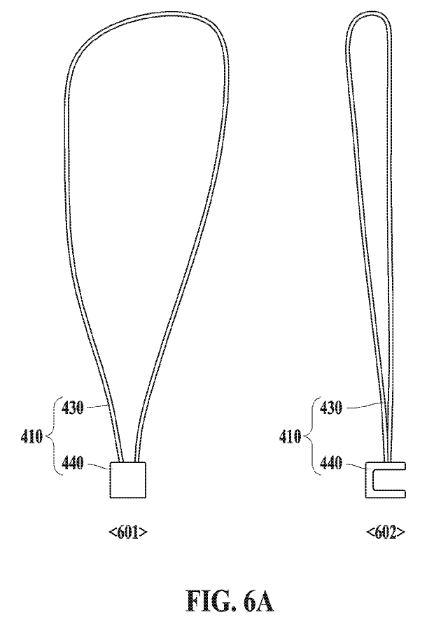

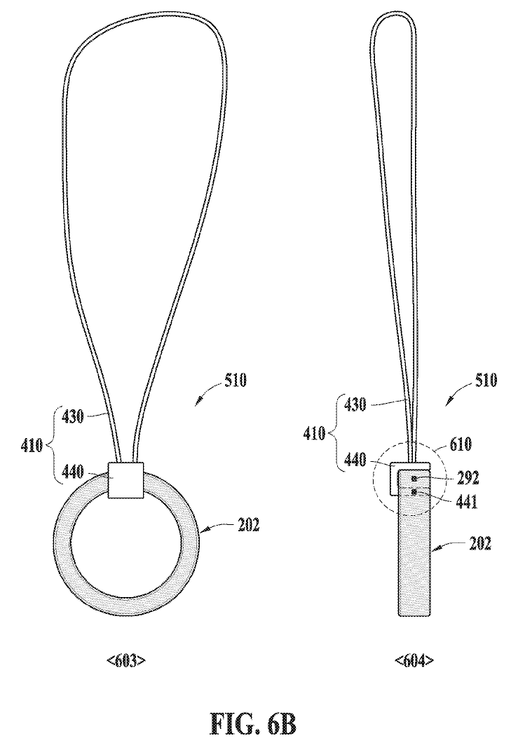

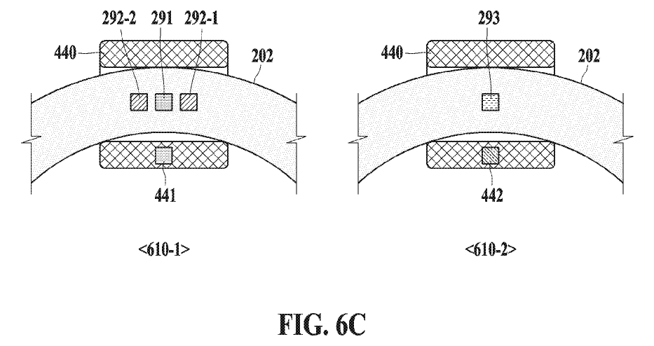

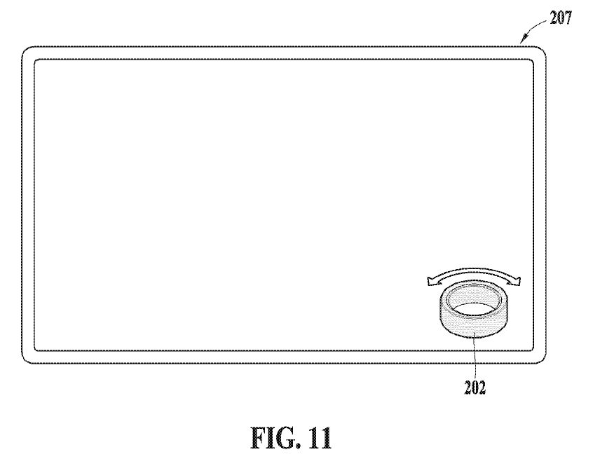

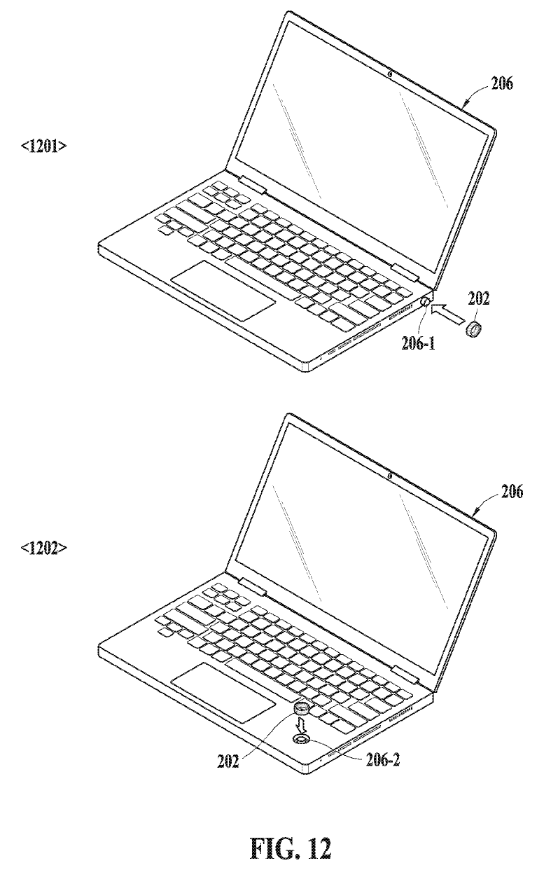

Referring to FIG. 3B, in an embodiment, a front view 303 and a side view 304 of the ring electronic device 202 are illustrated. The ring electronic device 202 may further include a connecting portion 290. The connecting portion 290 may refer to a physical connecting portion for connection with another device (e.g., a ring accessory device or an external electronic device). In an embodiment, the connecting portion 290 may include a Hall sensor (or Hall-effect sensor) for detecting magnetic force of a magnetic body included in another device (e.g., see FIG. 5B or FIG. 11). The connecting portion 290 may include an area that is physically connected to another electronic device (e.g., see FIG. 6C or FIG. 12). Hereinafter, a ring accessory device that may be coupled to the ring electronic device 202 is described.

FIG. 4 is a diagram illustrating an embodiment of a structure of a ring accessory device.

Referring to FIG. 4, in an embodiment, a front view 401 and a side view 402 of the ring accessory device 410 are illustrated. In an embodiment, the ring accessory device 410 may be a necklace-shaped accessory that may be coupled to a ring electronic device (e.g., the ring electronic device 202 of FIG. 3A). The ring accessory device 410 may be worn around a user's neck.

In an embodiment, the ring accessory device 410 may include a coupling portion 420 and a wearing portion 430. The wearing portion 430 may be an area worn (e.g., resting) around a user's neck. The coupling portion 420 may be an area coupled (e.g., physically attached) to the ring electronic device 202. In an embodiment, the coupling portion 420 may be implemented in a size corresponding to the ring electronic device 202, for example. In an embodiment, the coupling between the ring electronic device 202 and the coupling portion 420 may be secured by an attraction force between a magnetic body included (e.g., disposed inside) in the ring electronic device 202 and a magnetic body included in the coupling portion 420. The coupling between the ring electronic device 202 and the ring accessory device 410 is described in detail with reference to FIGS. 5A and 5B.

FIGS. 5A and 5B are diagrams illustrating an embodiment of coupling of a ring electronic device and a ring accessory device.

Referring to FIG. 5A, in an embodiment, each of the ring electronic device 202 and the ring accessory device 410 may include a magnetic body. In an embodiment, the ring accessory device 410 may include magnetic bodies 421-1 to 421-4, for example. In an embodiment, the ring electronic device 202 may include magnetic bodies 291-1 to 291-4, for example. The magnetic bodies 421-1 to 421-4 and the magnetic bodies 291-1 to 291-4 may be implemented to correspond to each other. In an embodiment, the magnetic bodies 421-1 to 421-4 and the magnetic bodies 291-1 to 291-4 may be implemented in the same number, for example. In an embodiment, the magnetic bodies 421-1 to 421-4 and the magnetic bodies 291-1 to 291-4 may be implemented at corresponding positions, for example. In FIG. 5A, only four magnetic bodies are shown, but the disclosure is not limited thereto.

In an embodiment, the coupling between the ring electronic device 202 and the ring accessory device 410 may be secured by an attraction force generated between the magnetic bodies 291-1 to 291-4 included (e.g., disposed inside) in the ring electronic device 202 and the magnetic bodies 421-1 to 421-4 included in the ring accessory device 410.

Referring to FIG. 5B, in an embodiment, a front view 501 and a side view 502 of a combination 510 of a ring electronic device and a ring accessory device are illustrated.

In an embodiment, the coupling of the ring electronic device 202 to the ring accessory device 410 may be detected by Hall sensors (e.g., 292-1 and 292-2 of FIG. 5A) (e.g., 292 of FIG. 5B) included in the ring electronic device 202. The Hall sensors 292-1 and 292-2 may detect magnetic force of the magnetic bodies 421-1 to 421-4 included in the ring accessory device 410. When the Hall sensors 292-1 and 292-2 detect the magnetic force of the magnetic bodies 421-1 to 421-4 of the ring accessory device 410 as well as the magnetic force of the magnetic bodies 291-1 to 291-4 of the ring electronic device 202, the ring electronic device 202 may detect coupling with the ring accessory device 410. By detecting a unique magnetic value of the ring accessory device 410 by the Hall sensors 292-1 and 292-2, the ring electronic device 202 may identify a device (e.g., the ring accessory device 410) coupled to itself. In an embodiment, when a magnetic value detected by the Hall sensors 292-1 and 292-2 is different from a stored value, the ring electronic device 202 may not update the operation mode.

In an embodiment, the number of Hall sensors is not limited to two as shown in FIG. 5A, and the ring electronic device 202 may include only one Hall sensor. The Hall sensors 292-1 and 292-2 may be sensors using a hall effect (e.g., a voltage is generated in a vertical direction of a magnetic field and a current when a magnetic field is applied to a conductor through which a current flows). The Hall sensors 292-1 and 292-2 may be classified as analog Hall sensors or digital Hall sensors. The Hall sensors 292-1 and 292-2 may detect a direction and magnitude of a magnetic field.

In an embodiment, the ring electronic device 202 may detect its own rotation direction. Through the Hall sensors 292-1 and 292-2, the ring electronic device 202 may detect its own rotation direction (e.g., a clockwise or counterclockwise rotation direction).

In an embodiment, the ring electronic device 202 may detect its own rotation angle. Through the Hall sensors 292-1 and 292-2, the ring electronic device 202 may detect a coupling state that is changed (e.g., changes in magnetic force) according to its rotation. In an embodiment, when four magnetic bodies are provided as shown in FIG. 5A, the ring electronic device 202 may detect its own rotation angle in 90-degree increments, for example. In an embodiment, when 12 magnetic bodies are provided in the ring electronic device 202, the ring electronic device 202 may detect its own rotation angle in 30-degree increments, for example. Additionally, the ring electronic device 202 may use interpolation to detect a rotation angle more precisely.

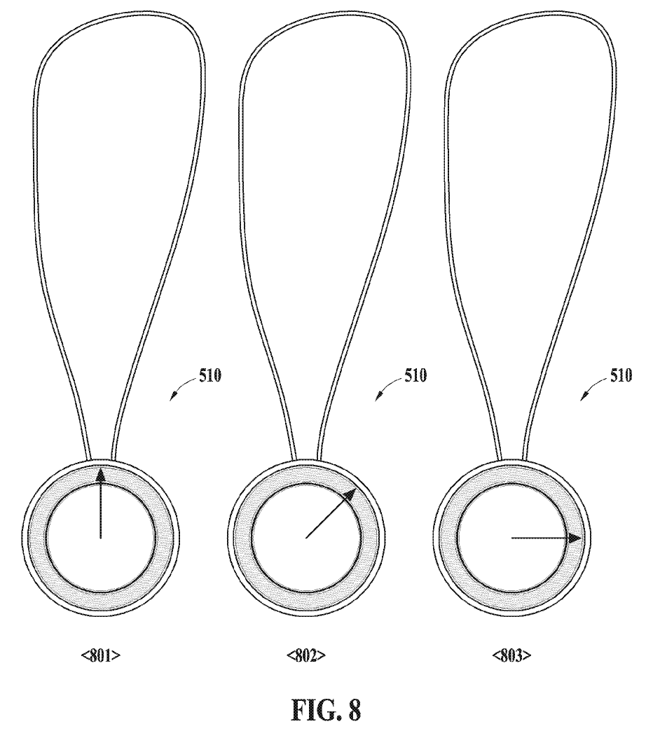

In an embodiment, the ring electronic device 202 may update an operation mode of the ring electronic device 202, based on the detection of a rotation (e.g., the detection of a rotation direction and/or rotation angle). The operation mode of the ring electronic device 202 and updates of the operation mode are described in detail with reference to FIG. 8.

FIGS. 6A to 6C are diagrams illustrating an embodiment of coupling of a ring electronic device and a ring accessory device.

Referring to FIG. 6A, in an embodiment, a front view 601 and a side view 602 of the ring accessory device 410 are illustrated. The ring accessory device 410 may be a necklace-shaped accessory that may be coupled to a ring electronic device (e.g., the ring electronic device 202 of FIG. 3A). The ring accessory device 410 may be worn around a user's neck.

In an embodiment, the ring accessory device 410 may include the wearing portion 430 and a ring holder 440. The wearing portion 430 may be an area worn (e.g., resting) around a user's neck. The ring holder 440 may be an area coupled (e.g., physically attached) to the ring electronic device 202. The ring holder 440 may be implemented in a size in which the ring electronic device 202 may be inserted. The coupling between the ring electronic device 202 and the ring holder 440 may be secured by inserting the ring electronic device 202 into the ring holder 440.

Referring to FIG. 6B, in an embodiment, a front view 603 and a side view 604 of the combination 510 of a ring electronic device and a ring accessory device are illustrated. In an embodiment, based on a physical engagement between the ring electronic device 202 and the ring holder 440, the coupling between the ring electronic device 202 and the ring holder 440 may be secured, for example. In an embodiment, based on an attraction force generated between a magnetic body (e.g., the magnetic body 291 of FIG. 6C) included within the ring electronic device 202 and a magnetic body 441 (e.g., the magnetic body 441 included within the ring holder 440) included within the ring accessory device 410, the coupling between the ring electronic device 202 and the ring holder 440 may be secured, for example. With reference to FIG. 6C, a coupling area 610 of the ring electronic device 202 and the ring holder 440 is described in detail.

Referring to FIG. 6C, in an embodiment, a method of detecting a coupling between a ring electronic device and a ring accessory device may be identified. In an embodiment, referring to case 1610-1, the Hall sensors 292-1 and 292-2 included in the ring electronic device 202 may detect a magnetic force of the magnetic body 441 included in the ring holder 440 of the ring accessory device 410.

In an embodiment, referring to case 2610-2, a light-receiving sensor 293 included in the ring electronic device 202 may detect an optical signal of the ring accessory device 410. The optical signal of the ring accessory device 410 may be output from an emitter 442 included in the ring holder 440 of the ring accessory device 410. In an embodiment, to reduce the burden of continuously outputting optical signals, the ring accessory device 410 may further include a proximity sensor. The ring accessory device 410 that detects the proximity of the ring electronic device 202 through the proximity sensor may output an optical signal through the emitter 442. By detecting a unique optical signal (e.g., an optical signal having a unique period) of the ring accessory device 410 by the light-receiving sensor 293 of the ring electronic device 202, the ring electronic device 202 may identify a device (e.g., the ring accessory device 410) coupled to itself.

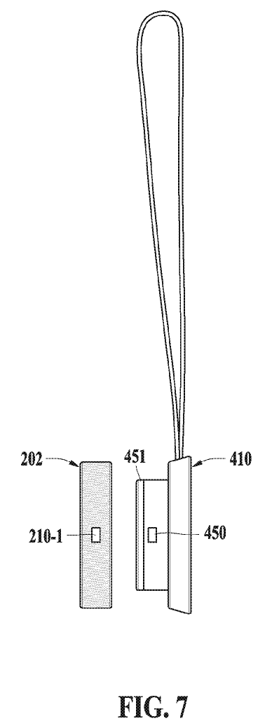

FIG. 7 is a diagram illustrating an embodiment of a ring accessory device.

Referring to FIG. 7, in an embodiment, the ring accessory device 410 may further include a communication circuit 450 and an input button 451. After coupling between the ring accessory device 410 and the ring electronic device 202 is secured, the ring accessory device 410 may transmit user input (e.g., pressing) information on the input button 451 to the ring electronic device 202. The ring accessory device 410 may transmit the user input information to the ring electronic device 202 via the communication circuit 450 (e.g., a communication circuit that supports NFC).

In an embodiment, the ring electronic device 202 may receive user input information via a communication circuit 210-1. In an embodiment, the ring electronic device 202 may broadcast the user input information, for example. In an embodiment, the ring electronic device 202 may transmit the user input information to a paired electronic device (e.g., the first device 201 of FIG. 1). The user input information may be intended to set (e.g., update) an operation mode of the ring electronic device 202, but the disclosure is not limited thereto, for example. Hereinafter, an operation mode of the ring electronic device 202 and updates of the operation mode are described.

FIG. 8 is a diagram illustrating an embodiment of an operation mode setting corresponding to a rotation of a ring electronic device.

Referring to FIG. 8, in an embodiment, a ring electronic device (e.g., the ring electronic device 202 of FIG. 3A) may detect a coupling state (e.g., a coupling state of the combination 510 of a ring electronic device and a ring accessory device) that has changed according to its rotation. In an embodiment, the ring electronic device (e.g., the ring electronic device 202 of FIG. 3A) may detect its own rotation angle with respect to a ring accessory device (e.g., the ring accessory device 410 of FIG. 4). In an embodiment, the ring electronic device 202 may set (e.g., update) an operation mode of the ring electronic device 202, based on detection (e.g., detection of a rotation direction and/or rotation angle) of the rotation, for example. The operation mode of the ring electronic device 202 may be set to correspond to the rotation angle of the ring electronic device 202.

In an embodiment, a first coupling state 801 may be an initial coupling state (e.g., a state in which the rotation of the ring electronic device 202 is 0 degrees) of the combination 510 of the ring electronic device and the ring accessory device. In an embodiment, in the first coupling state 801, the ring electronic device 202 may operate in a location tracking mode, for example. In an embodiment, a second coupling state 802 may be a second coupling state (e.g., a state in which the ring electronic device 202 is rotated 45 degrees clockwise relative to the initial coupling state) of the combination 510 of the ring electronic device and the ring accessory device. In an embodiment, in the second coupling state 802, the ring electronic device 202 may be changed from the location tracking mode to a health tracking mode, for example. In an embodiment, a third coupling state 803 may be a third coupling state (e.g., a state in which the ring electronic device 202 is rotated 90 degrees clockwise relative to the initial coupling state) of the combination 510 of the ring electronic device and the ring accessory device. In an embodiment, in the third coupling state 803, the ring electronic device 202 may be changed from the health tracking mode to a camera mode (e.g., a trigger for taking pictures), for example. As described above, it should be noted that the rotation angle detectable by the ring electronic device 202 is not limited to 45 degrees.

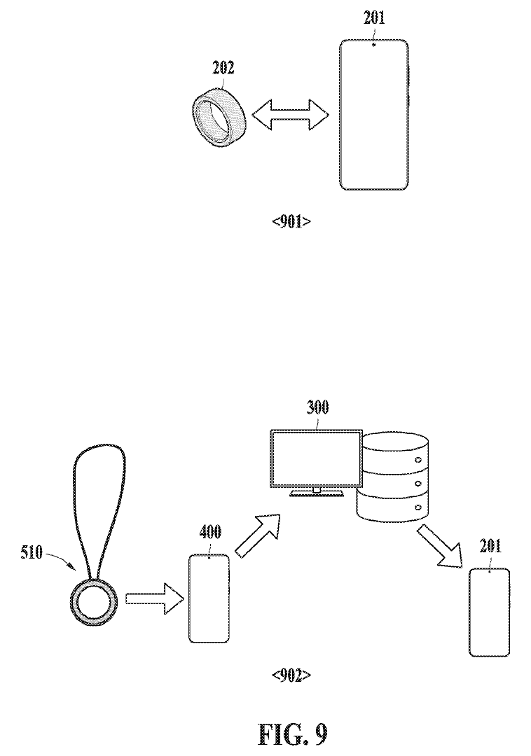

FIG. 9 is a diagram illustrating an embodiment of an operation mode of a ring electronic device.

Referring to FIG. 9, in an embodiment, operation modes (e.g., 901 and 902) of the ring electronic device 202 are illustrated. In an embodiment, a first mode 901 of the ring electronic device 202 may be a health tracking mode, for example. The health tracking mode may be a mode that tracks a health state and/or activity information of a user (e.g., a wearer of the ring electronic device 202), for example. The ring electronic device 202 may be worn on a finger of a user (e.g., an adult) and operated in the first mode 901. The first mode 901 may be a mode in which information sensed by a sensor (e.g., the sensors 260, 270, and/or 280 of FIG. 3A) included in the ring electronic device 202 is transmitted to the electronic device 201 (e.g., the first device 201 of FIG. 2) via a first communication method. In an embodiment, the first communication method may be a method of transmitting sensed information to the electronic device 201 paired with the ring electronic device 202, for example. In an embodiment, the first communication method may be a method of broadcasting sensed information to an outside, for example. In an embodiment, the first communication method may be a method of transmitting sensed information at a set cycle, for example.

In an embodiment, the second mode 902 of the ring electronic device 202 may be a location tracking mode. The location tracking mode may be a mode that uses a finding function in case of loss (e.g., see FIG. 2). In an embodiment, the ring electronic device 202 may be coupled (e.g., 510) to the ring accessory device 410, and driven in the second mode 902, for example. The combination 510 of the ring electronic device and the ring accessory device may be worn around a neck of a user (e.g., a child). The combination 510 of the ring electronic device and the ring accessory device may operate in the second mode 902 to track a location of a wearer (e.g., a child). In an embodiment, the second mode 902 may be a mode that releases the pairing with the electronic device 201, and deactivates at least one of the sensors activated in the first mode 901.

In an embodiment, the second mode 902 may be a mode in which identification information of the ring electronic device 202 and/or location information of the ring electronic device 202 are broadcast (e.g., data is transmitted to an unspecified number of people) to an outside via a second communication method. The second communication method may include a short-range communication method (e.g., Bluetooth, BLE, NFC, UWB communication, and/or Infra-red communication). The identification information of the ring electronic device 202 and/or location information of the ring electronic device 202 may be broadcast through an advertising packet, based on a short-range communication method. The electronic device 400 that receives an advertising packet may transmit the advertising packet to the server 300. The server 300 may transmit the advertising packet to the electronic device 201. Through the combination 510 of the ring electronic device and the ring accessory device operating in the second mode 902, a user (e.g., a guardian of a wearer (e.g., a child) of the combination 510 of the ring electronic device and the ring accessory device) of the electronic device 201 may track a location of the wearer (e.g., a child) of the combination 510 of the ring electronic device and the ring accessory device.

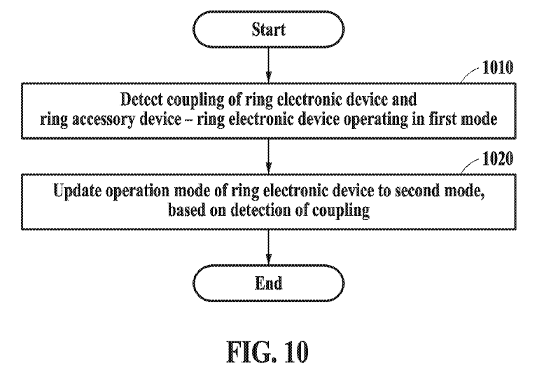

FIG. 10 is a diagram illustrating an embodiment of an operation method of a ring electronic device.

Operations 1010 and 1020 may be performed sequentially, but not necessarily performed sequentially. In an embodiment, the order of each operation 1010 and 1020 may be changed, and each operation 1010 and 1020 may be performed in parallel, for example.

In operation 1010, a ring electronic device (e.g., the ring electronic device 202 of FIG. 3A) in an embodiment may detect coupling (e.g., physical attachment) of a ring accessory device (e.g., the ring accessory device 410 of FIG. 4). The ring electronic device 202 may be operating in a first mode (e.g., the first mode 901 of FIG. 9).

In operation 1020, the ring electronic device 202 in an embodiment may update an operation mode of the ring electronic device 202 to a second mode (e.g., the second mode 902 of FIG. 9), based on detection of the coupling.

In an embodiment, the ring electronic device 202 may be worn on a finger of a user (e.g., an adult). The ring accessory device 410 may be worn around the user's neck. By coupling the ring electronic device 202 to the ring accessory device 410, the ring electronic device 202 may update its operation mode. The updated operation mode may be a mode (e.g., a second mode) that performs location tracking of the ring electronic device 202.

In an embodiment, the ring accessory device 410 coupled with the ring electronic device 202 may be worn around the user's neck. The ring electronic device 202 coupled with the ring accessory device 410 may track a location of a wearer (e.g., a child). When coupled with the ring accessory device 410, the ring electronic device 202 may track the location of the wearer (e.g., a child) by a finding function in case of loss (e.g., see FIG. 2) (e.g., by broadcasting an advertising packet).

FIG. 11 is a diagram illustrating an embodiment of coupling of a ring electronic device and an electronic device.

Referring to FIG. 11, in an embodiment, the ring electronic device 202 may be coupled (e.g., physically attached) to the electronic device 207 (e.g., the seventh device 207 of FIG. 2) (e.g., a tablet). In an embodiment, the ring electronic device 202 may be coupled to or disposed on at least a portion of a display of the electronic device 207, for example. In an embodiment, the ring electronic device 202 coupled to the electronic device 207 may operate as an input device of the electronic device 207.

In an embodiment, the ring electronic device 202 may detect coupling with the electronic device 207. In an embodiment, the coupling between the ring electronic device 202 and the electronic device 207 may be secured by an attraction force between a magnetic body included in the ring electronic device 202 and a magnetic body included in the electronic device 207, for example. Detection of the coupling between the ring electronic device 202 and the electronic device 207 may be performed by a Hall sensor. Since the description related to the above is described in detail with reference to FIGS. 5A and 5B, a repeated description is omitted.

In an embodiment, based on detection of the coupling of the ring electronic device 202 to the electronic device 207, the ring electronic device 202 may update its operation mode. The updated operation mode may be a mode in which the ring electronic device 202 operates as an input device of the electronic device 207.

In an embodiment, the ring electronic device 202 may broadcast an advertising packet including identification information of the ring electronic device 202 and/or location information of the ring electronic device 202, based on a short-range communication method. The location information of the ring electronic device 202 may be obtained based on a location measuring circuit (e.g., a GPS circuit) (or a GPS sensor) included in the ring electronic device 202. The electronic device 207 may receive the advertising packet. In an embodiment, the electronic device 207 may selectively release its security lock based on the identification information of the ring electronic device 202, for example. In an embodiment, when the identification information of the ring electronic device 202 is stored in the electronic device 207, the electronic device 207 may release the security lock, for example.

In an embodiment, the electronic device 207 that has released the security lock may use a rotation of the ring electronic device 202 as input data. The electronic device 207 may detect the rotation of the ring electronic device 202. The electronic device 207 may use data corresponding to the rotation as its own input data. In an embodiment, when the electronic device 207 is able to detect the rotation of the ring electronic device 202, the ring electronic device 202 may deactivate all sensors included in the ring electronic device 202.

In an embodiment, when the electronic device 207 is unable to detect the rotation of the ring electronic device 202, the ring electronic device 202 may activate only the Hall sensor among the sensors included in the ring electronic device 202. The ring electronic device 202 may detect the rotation of the ring electronic device 202 through the Hall sensor, and transmit data corresponding to the rotation to the electronic device 207. The electronic device 207 may use the data received from the ring electronic device 202 as input data.

FIG. 12 is a diagram illustrating an embodiment of coupling of a ring electronic device and an electronic device.

Referring to FIG. 12, in an embodiment, the ring electronic device 202 may be coupled (e.g., physically attached) to the electronic device 206 (e.g., the sixth device 206 of FIG. 2) (e.g., a laptop). In an embodiment, the ring electronic device 202 may be coupled to at least a portion of the electronic device 206. The ring electronic device 202 coupled to the electronic device 206 may operate as an input device of the electronic device 206.

In an embodiment, the ring electronic device 202 may detect coupling with the electronic device 206. In an embodiment, the coupling of the ring electronic device 202 to the electronic device 206 may be based on an engagement between a physical structure (e.g., 206-1 or 206-2) included in the electronic device 206 and the ring electronic device 202 (e.g., see 1201), for example. In an embodiment, the coupling of the ring electronic device 202 to the electronic device 206 may be secured by an attraction force between a magnetic body included in the ring electronic device 202 and a magnetic body included in the electronic device 206 (e.g., see 1202), for example.

In an embodiment, based on detection of the coupling of the ring electronic device 202 to the electronic device 206, the ring electronic device 202 may update its operation mode. The updated operation mode may be a mode in which the ring electronic device 202 operates as an input device of the electronic device 206.

In an embodiment, the ring electronic device 202 may broadcast an advertising packet including identification information of the ring electronic device 202 and/or location information of the ring electronic device 202, based on a short-range communication method. The electronic device 206 may receive the advertising packet. In an embodiment, the electronic device 206 may selectively release its security lock based on the identification information of the ring electronic device 202, for example. In an embodiment, when the identification information of the ring electronic device 202 is stored in the electronic device 206, the electronic device 206 may release the security lock, for example.

In an embodiment, the electronic device 206 that has released the security lock may use a rotation of the ring electronic device 202 as input data. The electronic device 206 may detect the rotation of the ring electronic device 202. The electronic device 206 may use data corresponding to the rotation as its own input data. In an embodiment, when the electronic device 206 is able to detect the rotation of the ring electronic device 202, the ring electronic device 202 may deactivate all sensors included in the ring electronic device 202.

In an embodiment, when the electronic device 206 is unable to detect the rotation of the ring electronic device 202, the ring electronic device 202 may activate only a Hall sensor among the sensors included in the ring electronic device 202. The ring electronic device 202 may detect the rotation of the ring electronic device 202 through the Hall sensor, and transmit data corresponding to the rotation to the electronic device 206. The electronic device 206 may use the data received from the ring electronic device 202 as input data.

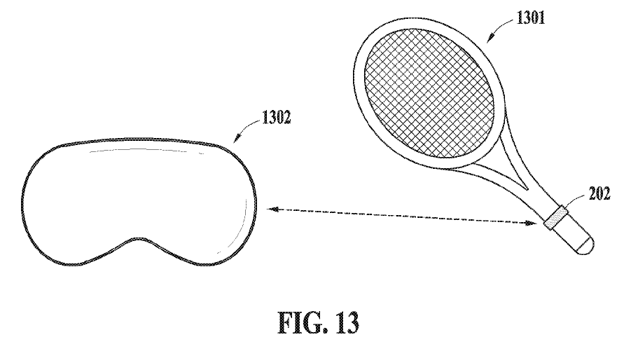

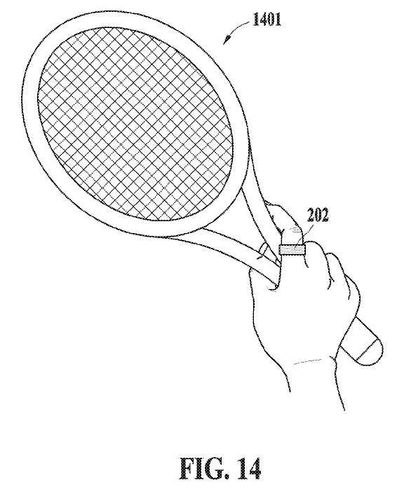

FIGS. 13 and 14 are diagrams illustrating an embodiment of coupling of a ring electronic device and an electronic device.

Referring to FIG. 13, in an embodiment, the ring electronic device 202 may communicate with a ring accessory device 1301 and an electronic device 1302. In an embodiment, the ring accessory device 1301 may be a device for a racket sports game (e.g., a tennis game). The ring accessory device 1301 may output vibrations to a user through a vibration element. In an embodiment, the ring electronic device 202 may be physically coupled to the ring accessory device 1301, for example. The user may swing the ring accessory device 1301, and the ring electronic device 202 may sense acceleration information through a sensor (e.g., the inertial sensor 260 of FIG. 3A). The ring electronic device 202 may transmit the acceleration information to the electronic device 1302. In an embodiment, the electronic device 1302 may process the acceleration information to generate a vibration generation request, for example. The electronic device 1302 may transmit the vibration generation request to the ring electronic device 202. The ring electronic device 202 may request the ring accessory device 1301 to output vibration based on the vibration generation request. In another embodiment, the electronic device 1302 may process the acceleration information and request the ring accessory device 1301 to generate vibration.

Referring to FIG. 14, in an embodiment, the ring electronic device 202 may directly process acceleration information and output vibration. The ring electronic device 202 may be connected to a ring accessory device 1401. The user may swing the ring accessory device 1401, and the ring electronic device 202 may sense acceleration information through a sensor (e.g., the inertial sensor 260 of FIG. 3A). In an embodiment, the ring electronic device 202 may process the acceleration information and directly output vibration. The ring electronic device 202 may also function as a device that provides haptic feedback to the user.

An operation method of a ring electronic device (e.g., the ring electronic device 202 of FIG. 3A) in an embodiment may include detecting coupling with a ring accessory device (e.g., the ring accessory device 410 of FIG. 4) while the ring electronic device is operating in a first mode. The operation method of the ring electronic device may include updating an operation mode of the ring electronic device to a second mode based on the detection of the coupling. The first mode may be a mode of transmitting information sensed by a sensor included in the ring electronic device to an external electronic device (e.g., the first device 201 of FIG. 9) through a first communication method. The second mode may be a mode of broadcasting information stored in the ring electronic device to an outside through a second communication method in order to track a location of the ring electronic device.

In an embodiment, the first communication method may be a method of transmitting the sensed information to an external electronic device paired with the ring electronic device.

In an embodiment, the second communication method may include a short-range communication method. The stored information may be broadcast through an advertising packet including identification information of the ring electronic device or location information of the ring electronic device, based on the short-range communication method.

In an embodiment, the second mode may be a mode in which the pairing with the external electronic device is released, and at least one of sensors activated in the first mode is deactivated.

In an embodiment, the coupling of the ring electronic device to the ring accessory device may be secured by an attraction force generated between a magnetic body (e.g., magnetic bodies 291-1 to 291-4 of FIG. 5A) included in the ring electronic device and a magnetic body (e.g., magnetic bodies 421-1 to 421-4 of FIG. 5A) included in the ring accessory device.

In an embodiment, the detecting of the coupling with the ring accessory device may be performed by detecting a magnetic force of the magnetic body included in the ring accessory device by a Hall sensor (e.g., the Hall sensors 292-1 and 292-2 of FIG. 5A) (e.g., the Hall sensor 292 of FIG. 5B) included in the ring electronic device.

In an embodiment, the coupling of the ring electronic device to the ring accessory device may be secured by the ring electronic device being inserted into a ring holder (e.g., the ring holder 440 of FIG. 6A) of the ring accessory device.

In an embodiment, the detecting of the coupling with the ring accessory device may be performed by detecting an optical signal of the ring accessory device by a light sensor (e.g., the light-receiving sensor 293 of FIG. 6C) included in the ring electronic device.

In an embodiment, the detecting of the coupling with the ring accessory device may include determining a type of the ring accessory device by detecting a unique value of the ring accessory device by a sensor included in the ring electronic device.

In an embodiment, the operation method of the ring electronic device may further include detecting a rotation of the ring electronic device. The operation method of the ring electronic device may further include updating an operation mode of the ring electronic device based on the detection of the rotation.

In an embodiment, the detecting of the rotation of the ring electronic device may be performed by detecting a coupling state changed according to the rotation by a sensor included in the ring electronic device.

In an embodiment, the updating of the operation mode may include updating the operation mode of the ring electronic device to an operation mode corresponding to a rotation angle of the ring electronic device among a plurality of operation modes of the ring electronic device.

A ring electronic device (e.g., the ring electronic device 202 of FIG. 3A) in an embodiment may include a wireless communication circuit (e.g., the wireless communication circuit 210 of FIG. 3A) configured to transmit and receive a wireless signal. The ring electronic device may include a processor (e.g., the processor 220 of FIG. 3A) operatively connected to the wireless communication circuit 210. The ring electronic device may include memory (e.g., the memory 230 of FIG. 3A) storing instructions. The instructions, when executed individually or collectively by the processor, may cause the ring electronic device to detect coupling of the ring electronic device to an external electronic device (e.g., the electronic device 206 of FIG. 12 or the electronic device 207 of FIG. 11). The instructions, when executed individually or collectively by the processor, may cause the ring electronic device to update an operation mode of the ring electronic device based on the detection of the coupling. The updated operation mode may be a mode in which the ring electronic device operates as an input device of the external electronic device.

In an embodiment, the instructions, when executed individually or collectively by the processor, may cause the ring electronic device to broadcast an advertising packet including identification information of the ring electronic device or location information of the ring electronic device, based on a short-range communication method. The external electronic device may selectively release its security lock based on the identification information.

In an embodiment, the updated operation mode may include a first mode that deactivates all sensors included in the ring electronic device.

In an embodiment, the external electronic device may detect rotation of the ring electronic device in response to the first mode, and may use data corresponding to the rotation as input data of the external electronic device.

In an embodiment, the updated operation mode may include a second mode that activates only a Hall sensor among sensors included in the ring electronic device, detects the rotation of the ring electronic device through the Hall sensor, and transmits the data corresponding to the rotation to the external electronic device.

In an embodiment, the external electronic device may use the data received from the ring electronic device as input data of the external electronic device, in response to the second mode.

In an embodiment, the coupling of the ring electronic device to the external electronic device may be secured by an attraction force generated between a magnetic body included in the ring electronic device and a magnetic body included in the external electronic device. The coupling of the ring electronic device to the external electronic device may be secured based on an engagement between a physical structure included in the external electronic device and the ring electronic device.

The electronic device in various embodiments may be one of various types of electronic devices. The electronic devices may include a portable communication device (e.g., a smartphone), a computer device, a portable multimedia device, a portable medical device, a camera, a wearable device, or a home appliance, for example. In an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other features (e.g., importance or order). It is to be understood that when an element (e.g., a first element) is referred to, with or without the term "operatively" or "communicatively", as "coupled with," "coupled to," "connected with," or "connected to" another element (e.g., a second element), it means that the element may be coupled with the other element directly (e.g., wiredly), wirelessly, or via a third element.

As used in connection with various embodiments of the disclosure, the term "module" may include a unit implemented in hardware, software, or firmware, and may interchangeably be used with other terms, e.g., "logic," "logic block," "part," or "circuitry". A module may be a single integral component, or a minimum unit or part thereof, adapted to perform one or more functions. In an embodiment, the module may be implemented in a form of an application-specific integrated circuit (ASIC), for example.

Various embodiments as set forth herein may be implemented as software (e.g., a program) including one or more instructions that are stored in a storage medium (e.g., an internal memory or external memory) that is readable by a machine (e.g., the electronic device). In an embodiment, a processor (e.g., the processor) of the machine (e.g., the electronic device) may invoke at least one of the one or more instructions stored in the storage medium, and execute it, with or without using one or more other components under the control of the processor, for example. This allows the machine to be operated to perform at least one function according to the at least one instruction invoked. The one or more instructions may include code generated by a compiler or code executable by an interpreter. The machine-readable storage medium may be provided in the form of a non-transitory storage medium. The term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

In an embodiment, a method in various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore^{TM}), or between two user devices (e.g., smart phones) directly. When distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, in various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An operation method of a ring electronic device including sensors, the operation method comprising:
detecting coupling with a ring accessory device while the ring electronic device is operating in a first mode; and
updating an operation mode of the ring electronic device to a second mode based on the detecting the coupling,
wherein the first mode is a mode of transmitting information sensed by a sensor among the sensors included in the ring electronic device to an external electronic device through a first communication method, and
the second mode is a mode of broadcasting information stored in the ring electronic device to an outside through a second communication method and tracking a location of the ring electronic device.

2. The operation method of claim 1, wherein
the first communication method is a method of transmitting the sensed information to the external electronic device paired with the ring electronic device,
the second communication method comprises a short-range communication method, and
the stored information is broadcast through an advertising packet comprising at least one of identification information of the ring electronic device or location information of the ring electronic device, based on the short-range communication method.

3. The operation method of claim 1, wherein
the second mode is a mode in which the pairing with the external electronic device is released, and at least one of sensors activated in the first mode among the sensors is deactivated.

4. The operation method of claim 1, wherein
the coupling the ring electronic device to the ring accessory device is secured by an attraction force generated between a magnetic body included in the ring electronic device and a magnetic body included in the ring accessory device, or secured by the ring electronic device being inserted into a ring holder of the ring accessory device.

5. The operation method of claim 1, wherein
the detecting the coupling with the ring accessory device is performed by detecting a magnetic force of the magnetic body included in the ring accessory device by the sensor which is a Hall sensor included in the ring electronic device, or
by detecting an optical signal of the ring accessory device by the sensor which is a light sensor included in the ring electronic device.

6. The operation method of claim 1, wherein
the detecting the coupling with the ring accessory device comprises:
determining a type of the ring accessory device by detecting a unique value of the ring accessory device by the sensor included in the ring electronic device.

7. The operation method of claim 1, further comprising:
detecting a rotation of the ring electronic device by detecting a coupling state changed according to the rotation of the ring electronic device by the sensor included in the ring electronic device; and
updating the operation mode of the ring electronic device based on the detection of the rotation.

8. The operation method of claim 1, wherein
the updating the operation mode comprises:
updating the operation mode of the ring electronic device to an operation mode corresponding to a rotation angle of the ring electronic device among a plurality of operation modes of the ring electronic device.

9. A ring electronic device comprising:
a wireless communication circuit configured to transmit and receive a wireless signal;
a processor operatively connected to the wireless communication circuit; and
memory storing instructions which, when executed individually or collectively by the processor, cause the ring electronic device to:
detect coupling of the ring electronic device to an external electronic device, and
update an operation mode of the ring electronic device based on the detection of the coupling,
wherein the updated operation mode is a mode in which the ring electronic device operates as an input device of the external electronic device.

10. The ring electronic device of claim 9, wherein
the instructions, when executed individually or collectively by the processor, cause the ring electronic device to:
broadcast an advertising packet comprising at least one of identification information of the ring electronic device or location information of the ring electronic device, based on a short-range communication method, and
wherein the external electronic device selectively releases its security lock based on the identification information.

11. The ring electronic device of claim 9, wherein
the updated operation mode comprises:
a first mode which deactivates an entirety of sensors included in the ring electronic device.

12. The ring electronic device of claim 11, wherein
the external electronic device is:
configured to detect rotation of the ring electronic device in response to the first mode, and uses data corresponding to the rotation as input data of the external electronic device.

13. The ring electronic device of claim 9, wherein
the updated operation mode comprises:
a second mode which activates only a Hall sensor among the sensors included in the ring electronic device, detects the rotation of the ring electronic device through the Hall sensor, and transmits the data corresponding to the rotation to the external electronic device.

14. The ring electronic device of claim 13, wherein
the external electronic device:
uses the data received from the ring electronic device as input data of the external electronic device, in response to the second mode.

15. The ring electronic device of claim 9, wherein
the coupling of the ring electronic device to the external electronic device is:
secured by an attraction force generated between a magnetic body included in the ring electronic device and a magnetic body included in the external electronic device, or
secured based on an engagement between a physical structure included in the external electronic device and the ring electronic device.
